(19) United States
(12) Patent Application Publication
(10) Pub. No.: US 2007/0218981 A1
(43) Pub. Date: Sep. 20, 2007

(54) Casino no-ticket in cashless methods allowing the redemption of large prizes

(75) Inventor: Thierry Brunet De Courssou, Henderson, NV (US)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: CYBERVIEW TECHNOLOGY, INC., Palo Alto, CA (US)

(21) Appl. No.: 11/752,916

(22) Filed: May 23, 2007

Related U.S. Application Data
(63) Continuation-in-part of application No. 10/826,686, filed on Apr. 15, 2004, now Pat. No. 7,232,371.

(51) Int. Cl. A63F 13/12

(52) U.S. Cl. 463/25

(57) ABSTRACT

Methods for reducing reliance on the need to use a physical payment instrument in substitution for cash for wagering on gaming terminals. According to embodiments of the present invention, a player may use a secure cashless payment instrument that does not require presentation of the payment instrument through an automatic reader fitted to a gaming terminal. The cashless payment instrument may feature a third-party security code. The method may advantageously be used in small remote gaming facilities such as in island holiday resorts, in cruise ships and on-board international flights, for example.

### 1. CROSS-REFERENCE TO RELATED APPLICATIONS

The present application is a continuation-in-part of co-pending and commonly assigned application Ser. No. 10/826,686, filed Apr. 15, 2004, which is hereby incorporated herein by reference in its entirety, and from which application priority is hereby claimed under 35 U.S.C. §120.

### BACKGROUND OF THE INVENTION

### 1. Field of the Invention

This invention relates generally to the field of pay computer-controlled games, either games of skills or games of chance, and more particularly to the field of cashless payment.

### 2. Copyright Notice/Permission

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright 2004, Cyberscan Technology Inc., All Rights Reserved.

### 3. Description of the Related Art

Cashless solutions such as ticket-in and ticket out (TITO) as described in U.S. Pat. No. 6,048,269, such as player account cashless as described in U.S. Pat. No. 6,280,328, and such as smartcard cashless as described in U.S. Pat. No. 6,577,733, each require a physical instrument (anonymous bar-coded printed ticket in the first case, a magnetic player card in the second case and an electronic wallet smartcard in the third case). Each of the patents listed above is hereby incorporated herein by reference in its entirety. In the first case (TITO), there is a requirement to fit a ticket reader as well as a ticket printer in each gaming terminal to print a ticket when the player presses the cash-out button. The printed ticket then must be presented to the cashier for cash redemption. Alternatively, the printed ticket may be inserted in another gaming terminal via a ticket reader to continue playing. Ticket printers and ticket readers, however, are complex and expensive devices that require immediate attention from trained technical staff in the case of paper jams or a malfunction. Moreover, accessing the inside of a gaming terminal requires following a strict security procedure that requires the use of special security keys and the maintenance of detailed paper logs. The requirement to have trained and trusted technical staff available permanently on site is not cost effective when considering small remote gaming facilities in island holiday resorts, cruise ships or on-board international flights.

### SUMMARY OF THE INVENTION

It is, therefore, an object of this invention to provide a method that obviates the need to use a physical payment instrument as a cash substitute when a player plays on a gaming terminal. According to embodiments of the present invention, to implement embodiments of the present invention, gaming terminals need not be equipped with any electromechanical cash or cashless enabling devices for accepting such a physical instrument (apart from a manual code entry) and for delivering/updating the physical instrument (such as the printing of a ticket or updating a smartcard wallet).

It is another object of this invention to provide a method for reducing reliance on the use a physical payment instrument as a cash substitute when a player plays on a gaming terminal. To implement embodiments of the present method, the gaming terminals need not be equipped with any electromechanical cash or cashless enabling devices, except for a basic keypad entry and/or a low-cost ticket printer.

According to an embodiment, the invention includes a plurality of network connected gaming terminals that do not have any electromechanical cash or cashless enabling devices or any type of contact-less code scanner (optical, video or electromagnetic). That is, the gaming terminals, apart from having the play enabling devices such as the game display and the interactive play devices (play buttons, arm-bandit, or touch-screen, for example) need not include a coin/token acceptor, a bill acceptor, a ticket reader, a barcode reader, a magnetic card reader, a smartcard reader, a contact-less ID reader, a coin/token hopper, a note dispenser or a ticket printer. According to an embodiment of the present invention, the gaming terminals may be fitted only with a LCD display, a touch screen and loudspeakers. Using an entry computer connected to a controlling central database, a cashier typically located in a cashier cage on the gaming premises directs and monitors the cashless operations that are the subject of the present inventions. The gaming terminals and the cashier operations are controlled by a central server database via the network. The cashier or cashiers may be equipped with electromechanical cashless enabling devices such as a ticket printer and a barcode reader. In addition, network-connected stations equipped with a barcode reader capable of automatically reading a code printed on a cashless ticket and communicating with the controlling central database may be placed in areas monitored by authorized personnel.

According to one embodiment of the present invention, a player remits cash to a cashier located in a cashier cage and receives in exchange a cashless payment instrument. The cashless payment instrument may be any substitute for physical cash (notes and coins), either using a portable physical medium such as a token, a bank check, a gold ingot or an advanced technology smartcard, or alternatively a non-physical medium such as a password agreed with a trustee or a bookmaker, a memorized Swiss bank numbered account, a voice recognized by a trustee or a biometric signature. The cashless payment instrument may comprise a unique identification code that is indexed in a database on the server. For example, the cashless payment instrument may be a printed ticket delivered by the cashier and may have an identification code. A credit corresponding to the remitted cash is associated with the identification code in the database. The player may carry the cashless payment instrument with him to a game terminal and present (e.g., provide) the code to the gaming machine. After the gaming machine accepts the presented code, the cashless payment instrument will be credited with the amount corresponding to the amount maintained at the database on the server.

Given that the cashless payment instrument may be a printed ticket showing a unique code (indexed in a central database) that is readable by the player and that may be accepted by the gaming terminal via manual entry using a keypad or a touch screen (and validated by the central database via the network), the cashless payment scenario up to this stage may be thought of as equivalent to a telephone ticket obtained at a convenience store, in which a code printed on a thermal-print voucher (or ticket) is keyed-in by the user on the telephone key-pad and the central server authorizes talking time until credit is exhausted. Such a scenario is, however, deemed to be insufficiently secure for use in gaming, as a malicious person may guess the code and use-up all the credit of the unsuspecting user who purchased the voucher in the first place. Although telephone card companies have put in place some basic security procedures, such as cutting the phone line after three false entries, and denying answering when a caller ID is suspicious, this scheme would be unacceptable to game regulators.

Therefore, for additional security, the cashless payment instrument according to embodiments of the present invention may be assigned a predetermined short lifetime, as measured from the issuance of the cashless payment instrument to the player. For example, the lifetime may be as short as 5 minutes for example, during which time a gaming terminal may accept the payment instrument. A cashless payment instrument whose lifetime has expired may be reset by the cashier. For additional security, the cashless payment instrument, upon being issued to the player, may be given an additional predetermined short lifetime (2 hours for example), during which the cashier may accept redemption of the cashless payment instrument, after which authorized personnel may have to intervene to determine the reason for the expiry.

According to another embodiment, upon being issued to the player, the cashless payment instrument may be given a two-level lifetime in which the first level lifetime is a predetermined short period of time such as 5 minutes for example, during which a gaming terminal may accept the cashless payment instrument and in which the second level life time is a predetermined short period of time such as 2 hours for example, after which the cashless payment instrument is no longer valid unless presented for examination to an on-site game regulator representative or other authorized personnel.

When the first level lifetime for a cashless payment instrument has not expired and the cashless payment instrument is not being used for playing on a gaming terminal, the cashless payment instrument is said to be “alive.” When the first level lifetime for a cashless payment instrument has not expired and the cashless payment instrument is being used for playing on a gaming terminal, the cashless payment instrument is said to be “locked”. When the first level lifetime has expired and the second lifetime has not expired, the cashless payment instrument is said to be “dormant.” When the second lifetime has expired, the cashless payment instrument is said to be “dead.” When a player is playing on a gaming terminal, the second level lifetime clock may be frozen until the cash out button is pressed. When the credit balance associated with a cashless payment instrument reaches zero, the cashless payment instrument is said to be “empty;” it becomes dead and the second-level lifetime is set to the expired state.

The first level lifetime may be selected so as to allow sufficient time for the player to choose a gaming terminal on which to play, and may be selected so as to be insufficient for a malicious person to successfully mount an attack by guessing the code of an alive payment instrument. If the cashless payment instrument is dormant or dead, no gaming terminal may accept the payment instrument. Upon being accepted by a gaming terminal and until the cash-out button is pressed (if credit is not zero), the cashless payment instrument is locked and may not be accepted by another gaming terminal. Similarly, when the credit reaches zero, the associated cashless payment instrument is dead may not be accepted by another gaming terminal and may not be cashed-out at the cashier.

When a cashless payment instrument is dormant (and is not dead), it may be reset to the alive state by presenting it to a cashier to “wake it up”—that is, to bring the cashless payment instrument from the dormant to the alive state. According to one embodiment, a device capable of automatically accepting the code associated with the cashless payment instrument may be placed close to a cashier, a security officer or a game regulator representative so that the player's face may be monitored. Such a device (hereafter called a “reactivation station”) may be a laser barcode scanner connected to the central database that emits a characteristic beep or noise when the cashless payment instrument is woken-up (or re-activated). Immediately upon recognizing a dormant cashless payment instrument via the reactivation station, the database server automatically resets the status of the dormant cashless payment instrument to alive, thus allowing the player to go and play on a gaming terminal. The fact that the player must present him or herself in person at a monitored location is believed to deter malicious people from repeatedly attempting to cheat the system. When a dormant cashless payment instrument is presented to a gaming terminal, a message displayed on the screen may indicate that the cashless payment instrument needs to be presented to a reactivation station before game play can proceed. Indeed in some gaming premises, the reactivation station may be substituted by a cashier performing the same reactivation operation.

If a cashless payment instrument becomes dead, for example after remaining dormant for a long time while the player is eating his dinner, the player must present his cashless payment instrument to a cashier to change its status back to alive. According to one embodiment of the present invention, a dead cashless payment instrument may not be resurrected back to the alive state by a reactivation station. This forces the player to present him or herself to the cashier or a game regulator representative. That the player has to show up in a place with security or game surveillance, and talk to a gaming representative, further deters repeated cheating attempts.

According to another embodiment, icons may be displayed on the cashier's screen representing dormant and dead cashless payment instruments which have been respectively denied by gaming terminals or reactivation stations, in order to be alerted of attempts made by potentially malicious people.

When the credit associated with a cashless payment instruments is zero, the cashless payment instruments is said to be “empty”. When an empty cashless payment instrument is presented to a gaming terminal, a message displayed on the screen may indicate that the credit associated with the cashless payment instrument is depleted and that the cashless payment instrument should be discarded (in a trash receptacle, for example, in the case of a printed ticket).

When a player hits the jackpot or wishes to cash-in his or her remaining credits or winnings by pressing the cash out button, he or she presents the cashless payment instrument to the cashier who may consult the central database to obtain authorization for payment.

When a player wins a jackpot, the gaming terminal may lock-up and a special visual signal may be activated. Thereafter, the player can no longer play or activate any function and must wait for an attendant or security person to initiate a verification procedure to ensure that the gaming terminal has not been tampered with. Upon completion of the verification procedure, the player can no longer play and must be paid. In this case, the player may not need to press the cash-out button to initiate the redemption process.

According to a further embodiment, for additional security whenever cashing out large winning sums such as subsequent to a progressive jackpot in which the win amount may be in the order of 20 million dollars, at the time a player originally remits cash to the cashier to get the cashless payment instrument in exchange, the player may be prompted to enter a secret PIN or password on a keypad/keyboard. The PIN or password is only known to the player and is stored in the central database together with the details of the cashless payment instrument and initial credit. Consequently, when the player leaves the gaming machine subsequent to a jackpot win or subsequent to pressing the cash-out button, he is confident that only he may claim the winnings by retyping his PIN number or password when presenting the cashless payment instrument to the cashier. The capability to enter a PIN may be an option given to the player or may be mandated by game regulation.

According to another embodiment, for significant additional security whenever cashing out large winning sums such as subsequent to a progressive jackpot whereby the win amount may be in the order of 20 million dollars, a third party security code (or security number) may be associated with the cashless payment instrument. For example, if the cashless payment instrument is a ticket printed on thermal paper, the code to be presented to the gaming machine is printed on the ticket by the thermal printer at the moment of issue, and the security number is preprinted on the back of the ticket with an inking process when the paper spool is made (thus the number is printed by a third party). Preferably, the security number may be printed in red such that it does not interfere with barcode scanning, laser and CCD barcode readers being blind to the color red. The security numbers may be printed frequently at regular intervals on the paper spool, for example every 10 cm, such that each printed ticket may have at least one security number readable on the back of the ticket. Security numbers may simply be unique sequential numbers printed at the back of the blank paper every 10 cm for example. In that case, no record of these numbers need be communicated to anyone. When a ticket is presented by a player for redemption of winnings or remaining credits, the cashier may systematically record the security number found on the back of the presented ticket together with other details needed for the redemption. Considering that statistically they may be one (1) ticket presented for redemption out of ten (10) tickets initially issued, there should be a recorded trace in the central database of 10% of the security numbers in a random distribution, to which may be associated the exact time at which the original ticket was issued.

Therefore, when a player presents a suspicious or a very large sum winning ticket for redemption, the cashier after entering the identification code printed on the ticket (by scanning the barcode printed on the ticket) simply keys-in the security number (or one of the security numbers) available on the back of the ticket, which security number is immediately processed at the central database. The central database recovers the exact issuing timestamp when the presented ticket was emitted, as well as the security numbers of the paid tickets that were originally issued before the presented ticket was issued (hereinafter, the “before ticket”) and after the presented ticket was issued (hereinafter, the “after ticket”). If the security number of the presented ticket is within the range delimited by the security numbers of the before ticket and the after ticket, then there is a high confidence that the ticket is genuine and the payment may be authorized.

It would be extremely difficult for a malicious person to forge a winning ticket having all three parameters correct: the identification code, the issuing timestamp and the security number. Indeed, the security numbering scheme may be further hardened by having the paper spool maker print pseudo random numbers (instead of sequential numbers) that are then recorded in a central database accessible by an authorized third party. During the verification process, the central database (or the cashier) would submit the security code of the presented ticket, the security code of the before ticket and the security code of the after ticket to the third party. The third party would then look-up the series of pseudo random numbers to confirm whether the security number of the presented ticket was pre-printed between the security number of the ticket having an issuing timestamp before the presented ticket and the security number of the ticket having an issuing timestamp after the presented ticket.

According to an embodiment thereof, the present invention is a cashless payment method for a gaming system having a plurality of network connected gaming machines. The method may include steps of issuing a ticket in exchange for money remitted by a player, the ticket including a first code that is pre-printed on the ticket and is indexed in a first database and a second code that is printed, independently of the first code, on the ticket at a time of issuance of the ticket and that is indexed in a second database that is independent of the first database, the second database storing a timestamp of a time at which the ticket was issued and a balance of credit set to the money remitted, the timestamp and the balance of credit being associated with the second code; accepting the issued ticket by a gaming machine of the gaming system selected by the player and crediting the gaming machine with the balance of credit associated with the second code printed on the ticket, the balance of credit being retrieved from the second database; enabling wagering on the gaming machine and updating the balance of credit in the second database as long as the balance of credit is greater than zero, and disallowing wagering when the balance of credit is zero, and enabling redemption of the balance of credit when the player has won a prize or has pressed a cash out button upon presentation of the ticket, the balance of credit being retrieved from the second database using the second code printed on the ticket, the redemption enabling step being rejected if the first code pre-printed on the presented ticket does not fall within a determined range of first codes in the first database, the range of first codes being determined by timestamps associated with second codes of previously redeemed tickets.

The first code may include a security code and the second code may include an identification code. The issuing step may be carried out with the timestamp and the balance of credit being stored in the second database as metadata associated with the second code. The redemption enabling step may be carried out with the range of first codes being bounded by a nearest first code of a first previously redeemed ticket that was issued before the presented ticket, as determined by the timestamp associated with the second code of the first previously redeemed ticket, and by a nearest first code of a second previously redeemed ticket that was issued after the presented ticket, as determined by the timestamp associated with the second code of the second previously redeemed ticket. The gaming machine may include a keyboard/keypad, touch screen and/or a pointing device, for example. The accepting step may include a step of accepting manual entry of the second code of the presented ticket via the keyboard/keypad, touch screen and/or the pointing device (or via any other input device coupled to the gaming machine). The second code may include an alphanumeric code, a password and/or a pass-phrase, for example.

The redemption enabling step may include printing a cash-out ticket, and the cash-out ticket may be the ticket. The issuing step further may include a step of accepting a first Personal Identification Number (PIN) from the player, the first PIN being stored in the second database and associated with the second code. The redemption enabling step further may include a step of accepting a second PIN from the player, and disallowing redemption if the second PIN does not match the first PIN stored in the second central database. The first PIN may be stored in the second database as metadata to the second code. The pre-printed first codes on sequentially issued tickets may be sequential or (pseudo) random.

The ticket issuing step may include a step of separating the issued ticket from a spool of tickets, the spool of tickets including a plurality of tickets having first codes pre-printed thereon in such a manner that after the separating step, one or more of the pre-printed first codes may be readable on the ticket issued to the player. The ticket issuing step may include a step of separating the issued ticket from a spool of cash-out tickets, the spool of cash-out tickets including a plurality of cash-out tickets having first codes pre-printed thereon in such a manner that after the separating step, one or more of the pre-printed first codes may be readable on the cash-out ticket issued to the player.

According to another embodiment thereof, the present invention is a cashless payment method for a gaming system having a plurality of network connected gaming machines. The method may include steps of issuing a ticket in exchange for money remitted by a player, the ticket including a first code that was pre-printed during manufacturing of the ticket and a second code that may be printed on the ticket at a time of issuance of the ticket; recording a timestamp of a time at which the ticket was issued and a balance of credit set to the money remitted, and associating the recorded timestamp and the balance of credit with the second code; accepting the issued ticket by a gaming machine of the gaming system selected by the player and crediting the gaming machine with the balance of credit associated with the second code printed on the ticket; enabling wagering on the gaming machine and updating the balance of credit in the second database as long as the balance of credit is greater than zero, and disallowing wagering when the balance of credit is zero, and enabling redemption of the balance of credit when the player has won a prize or has pressed a cash out button upon presentation of the ticket, the redemption enabling step being rejected if the first code pre-printed on the ticket does not fall within a determined range of first codes, the range of first codes being determined by recorded timestamps associated with second codes of previously redeemed tickets.

The first code may include a security code and the second code may include an identification code. The timestamp and the balance of credit being recorded as metadata associated with the second code. The redemption enabling step may be carried out with the range of first codes being bounded by a nearest first code of a first previously redeemed ticket that was issued before the presented ticket, as determined by the timestamp associated with the second code of the first previously redeemed ticket, and by a nearest first code of a second previously redeemed ticket that was issued after the presented ticket, as determined by the timestamp associated with the second code of the second previously redeemed ticket. The gaming machine may include one or more of a keyboard/keypad, touch screen, a pointing device or any other input device that may be coupled to the gaming machine. The accepting step may include a step of accepting manual entry of the second code of the presented ticket via the keyboard/keypad, touch screen and/or the pointing device. The second code may include an alphanumeric code, a password and/or a pass-phrase, for example. The redemption enabling step may include printing a cash-out ticket (the cash-out ticket may be the ticket). The issuing step further may include a step of accepting a first Personal Identification Number (PIN) from the player, the first PIN being associated with the second code and the redemption enabling step further may include a step of accepting a second PIN from the player, and disallowing redemption if the second PIN does not match the first PIN. The first PIN may be stored as metadata to the second code. The pre-printed first codes on sequentially issued tickets may be sequential or (pseudo) random.

The ticket issuing step may include a step of separating the issued ticket from a spool of tickets, the spool of tickets including a plurality of tickets having first codes pre-printed thereon in such a manner that after the separating step, one or more of the pre-printed first codes may be readable on the ticket issued to the player. The ticket issuing step may include a step of separating the issued ticket from a spool of cash-out tickets, the spool of cash-out tickets including a plurality of cash-out tickets having first codes pre-printed thereon in such a manner that after the separating step, one or more of the pre-printed first codes may be readable on the cash-out ticket issued to the player.

### BRIEF DESCRIPTION OF THE DRAWINGS

FIG. 1 shows elements of a secure cashless gaming system according to an embodiment of the present invention.

FIG. 2 shows a cashless ticket, according to an embodiment of the present invention.

FIG. 3 shows an embodiment of the present cashless payment method, according to an embodiment of the present invention.

FIG. 4 shows a 2nd-level lifetime lapse, according to an embodiment of the present invention.

FIG. 5 shows another embodiment of the present cashless payment method, according to an embodiment of the present invention.

FIG. 6 shows yet another embodiment of the present cashless payment method, according to an embodiment of the present invention.

FIG. 7 shows further aspects of a cashless payment method for a gaming system having a plurality of network connected gaming machines, according to further embodiments of the present invention.

FIG. 8 is a flowchart illustrating aspects of a method for redemption of cashless tickets, according to further embodiments of the present invention.

### DETAILED DESCRIPTION OF THE INVENTION

In the following detailed description of exemplary embodiments of the invention, reference is made to the accompanying drawings, which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

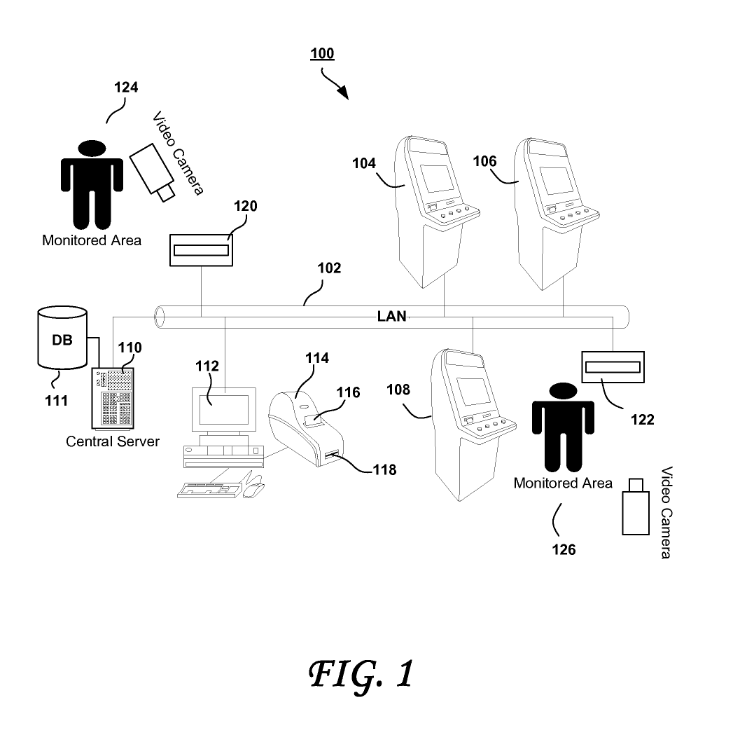

FIG. 1 illustrates elements of a system for cashless gaming, according to an embodiment of the present invention. As shown, reference numeral 100 shows a network connected gaming system comprising a plurality of gaming machines 104, 106 and 108, at least one payment verification station 112 located for example within a cashier cage, a central database 111 controlled by a central server 110 and at least one re-activation station 120, 122 located in an area monitored by gaming personnel and/or video surveillance 124, 126. The payment verification station 112 comprises a computer equipped with a printer 114 configured to print tickets 116 and a barcode scanner 118.

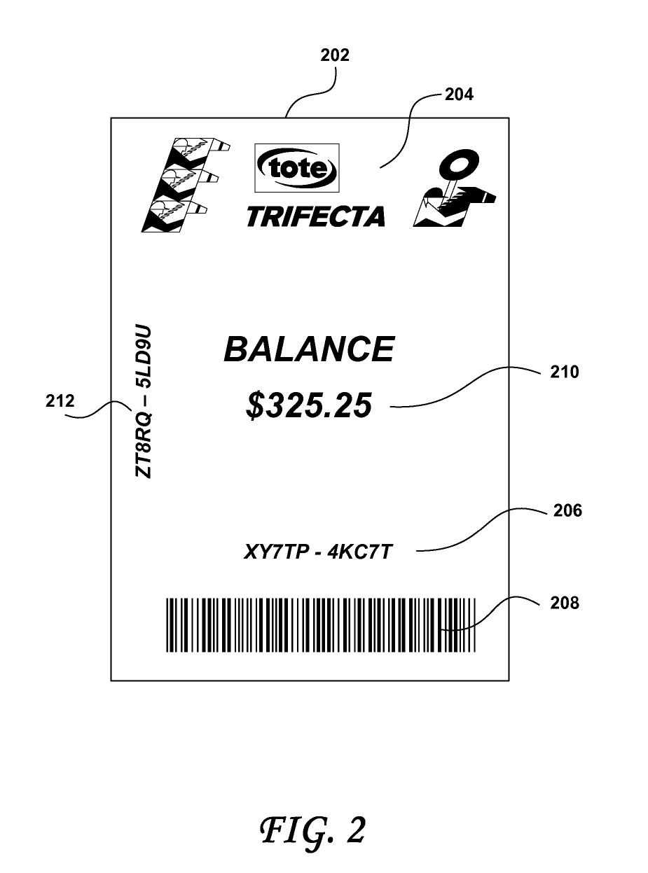

FIG. 2 shows an exemplary cashless ticket according to an embodiment of the present invention. The ticket 202 may include a logo 204, an identification code 206, a barcode 208 which may or may not be identical to the identification code 206, an amount 210 corresponding for example to the cash remitted when the cashless ticket 202 was issued to the player by the cashier and a security number 212. When the barcode 208 is not identical to the identification code 206, a link or association between these two numbers may be maintained at the central database 111. The security number 212 may have been pre-printed on the edge of the cashless ticket 202 or on the back of the cashless ticket 202 when the cashless ticket blanks (e.g., a spool of such cashless ticket blanks) were made. Alternatively, the security number 212 may be printed upon issuance of the cashless ticket 202 under the control of a secure process whereby the printing of the security number 212 cannot be predicted and may be verified by a third party.

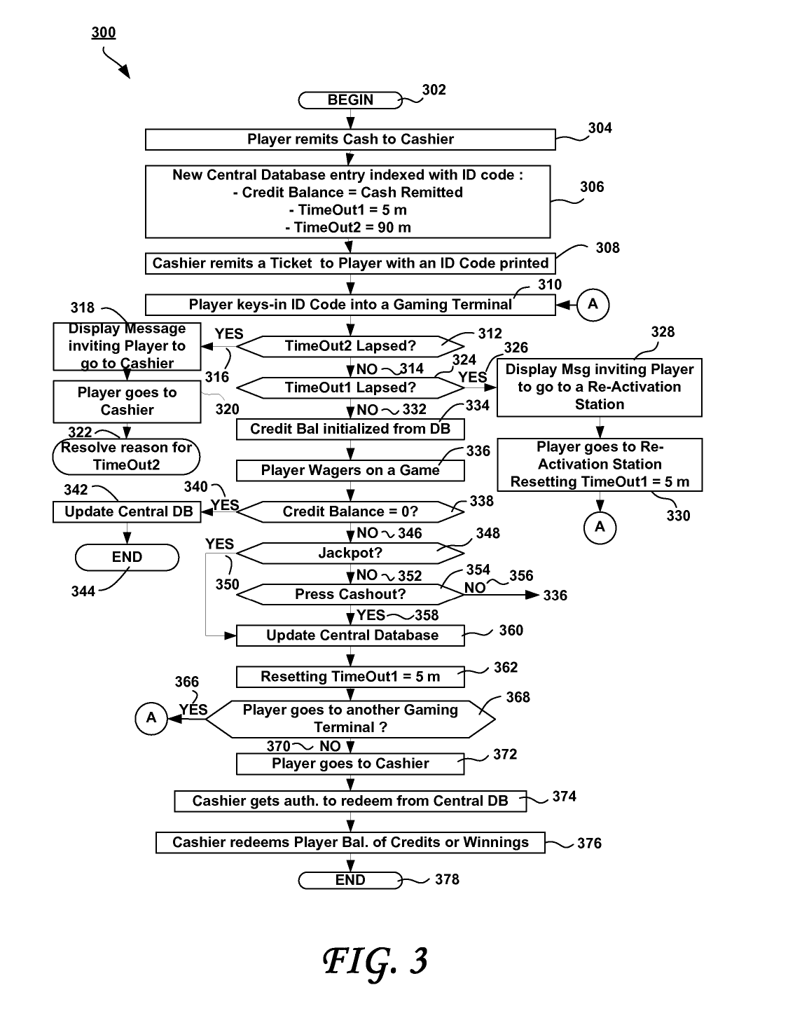

FIG. 3 illustrates a complete cash-in/cashless-play/cash-out cycle for a player according to a cashless procedure using a secure 2-level limited lifetime ticket method, according to an embodiment of the present invention. The cycle begins at 302 with a cash-in step in which the player remits cash to a cashier as shown at 304. The central server 110 and the database 111 create a new entry at 306 that is indexed with the ticket identification code 206 and that includes the credit balance 210 set to the amount of cash (or other form of tangible or electronic money) remitted by the player, a first timeout value set, for example, at 5 minutes and a second timeout value set, for example, at 90 minutes. The two timeouts are started (running).

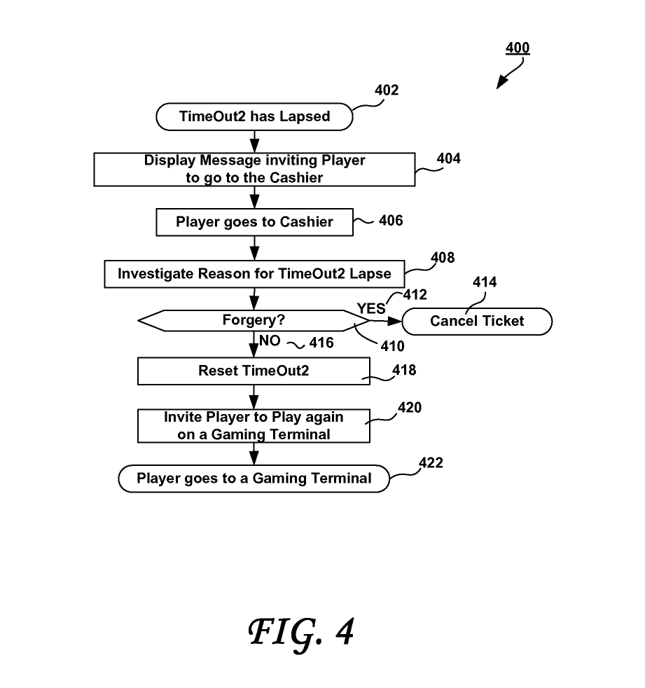

Step 308 calls for the cashier to remit a printed ticket (similar to that shown in FIG. 2, for example) to the player 308, the remitted cashless ticket including a readable identification code as illustrated in FIG. 2 at numeral 206. As shown at 310, the player then walks to a selected gaming terminal and enters the identification code via a touch-screen or a keypad, for example. The gaming terminal contacts the central server and database 110, 111 and recovers the data associated with the identification code 206, namely the credit balance 210, the running first timeout and the running second timeout. If the second timeout has lapsed as shown at 312, 316 then a message may be displayed informing the player that his ticket is no longer valid and inviting him, as shown at 318, to walk to the cashier 318 to sort out the issue. As called for by step 320, the player goes to the cashier where the reason for the timeout may be resolved, as shown at 322. The detailed procedure for resolving the timeout is shown at FIG. 4.

If the second timeout has not lapsed as shown at 312, 314, then the first timeout is checked. If the first timeout has lapsed as shown at 324, 326 then a message may be displayed informing the player that his ticket is no longer valid and inviting him to walk to a re-activation station to re-activate his ticket, as shown at 328. Thereafter, the player, as called for by step 330, goes the re-activation station that is monitored by gaming personnel and/or video surveillance and scans the tickets in front of the laser barcode scanner 120 or 122. If no reasons exist for not doing so, when the presented cashless ticket 202 is scanned, the first timeout is reset to its initial value as shown at 330 and the method reverts to step 310 whereupon the player goes to a selected gaming machine to key-in the identification code. Alternatively, the player may go to a cashier who may re-activate the ticket in a similar fashion as would the re-activation station.

If the first timeout has not lapsed as indicated at 324, 332, then the gaming terminal credit balance is initialized from the amount maintained in the central server and database 110, 111, as shown at 334. The player may then wager on a game, as indicated at 336. If the gaming terminal credit balance is zero as shown at 338 and 340, the central database 111 is updated at 342 and the player gaming cycle is terminated at 344. As shown at 338, 346, if the gaming terminal credit balance is not zero and if no jackpot is won at 348, 352 and if the player has not pressed the cash out button as indicated at 354, 356, then the player may wager for another game and the method may revert to step 336.

If a jackpot is won at 348, 350 or the cash out button is pressed at 354, 358, then the central database 111 is updated at 360 to reflect the current credit balance. The first timeout is reset to its initial value as shown at 362 in the central database 111. The player may chose to play on another gaming terminal as shown at 368, 366 and engage in the gaming cycle at step 310. Alternatively, the player may decide to walk to the cashier as indicated at 368, 370 and 372 to whom the ticket is presented. The central server and database 110, 111 may then authorize payment of the jackpot, which payment closes the cashless transaction. The cashier may then pay the balance of credits and/or winnings to the player at 376, which would close the cash out-out step at 378 of the cash-in/play/cash-out cycle.

According to another embodiment, whenever the gaming terminal is equipped with a low cost ticket printer such as found at supermarket cash registers, a cash-out ticket may be printed upon pressing the cash-out button or upon winning the jackpot. The ticket may be identical to the initially remitted ticket as shown at FIG. 2 except for the credit balance and other miscellaneous information, such as the time the ticket is printed. The identification code is unchanged. The credit balance shown on the ticket printed by the gaming terminal is simply information to the player. Only the identification code which is shown both on the originally remitted ticket and the cash-out/jackpot ticket is required to be given for other subsequent steps such as redemption or playing remaining credits on another gaming terminal. In a similar fashion, upon the credit balance reaching zero, an identical ticket may be printed by the gaming terminal showing a zero credit balance for information to the player.

FIG. 4 shows at 400 a method for resolving a 2nd-level lifetime timeout, according to an embodiment of the present invention. FIG. 4 illustrates the procedure associated with the resurrection (e.g., change of status to the alive state) of a lapsed (or dead) second level lifetime associated with a cashless ticket. When the second timeout has lapsed as indicated at 312 (FIG. 3) and reference numeral 402 in FIG. 4, a message may be displayed informing the player that his ticket is no longer valid and inviting him to walk to the cashier as indicated at 404 to resolve the issue. At step 408, the player goes to the cashier where the possibility of a forgery is examined at step 410. If forgery is suspected or established at 412, the case may be transferred to the game regulator representative, the ticket is cancelled at 414 and the central server and database 110, 111 is updated accordingly. If no forgery is suspected at step 416, the second timeout is reset to its initial value at 418 or alternatively set to a predetermined value and the central server and database 110, 111 is updated accordingly. The player is invited to play again on a gaming terminal, as shown at 420. The player may then walk to a gaming terminal of his choice as shown at step 422.

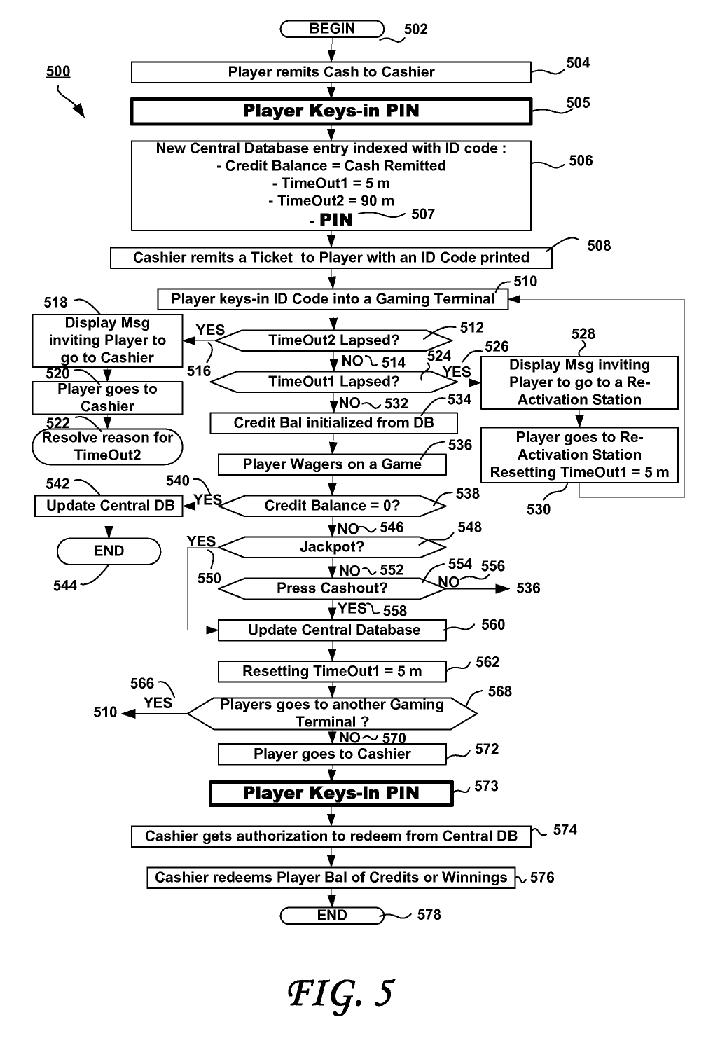

FIG. 5 shows at 500 a cash-in/cashless-play/cash-out cycle with a player PIN, according to an embodiment of the present invention. FIG. 5 illustrates a complete cash-in/cashless-play/cash-out cycle for a player using the secure 2-level limited lifetime ticket method described relative to FIG. 3, supplemented with the use of a player entered secret PIN for additional security. Diagram 500 is identical to diagram 300 in FIG. 3 except for the steps noted in bold and with thicker line boxes, as shown at 505, 507 and 573. For clarity, only these modified steps are detailed hereunder.

According to an embodiment of the present invention, for additional security when a player cashes out large winning sums such as subsequent to a progressive jackpot in which the win amount may be in the order of 20 million dollars, when the player originally remits cash to the cashier to obtain the cashless payment instrument in exchange, the player may enter a secret PIN 505 or password on a keypad/keyboard (or using any other suitable and secure input means). The PIN or password is only known to the player and is stored in the central database 111 together with the cashless payment instrument details and initial credit, as shown at 507. Consequently, when the player leaves the gaming machine subsequent to a jackpot win or subsequent to pressing the cash-out button, in order to claim his winnings at the cashier cage, he may be confident that only he may claim the winnings by retyping (or otherwise re-entering) his PIN number or password as shown at 673 when presenting the cashless payment instrument to the cashier. The capability to enter a PIN may be an option given to the player or be imposed by the prevailing game regulation.

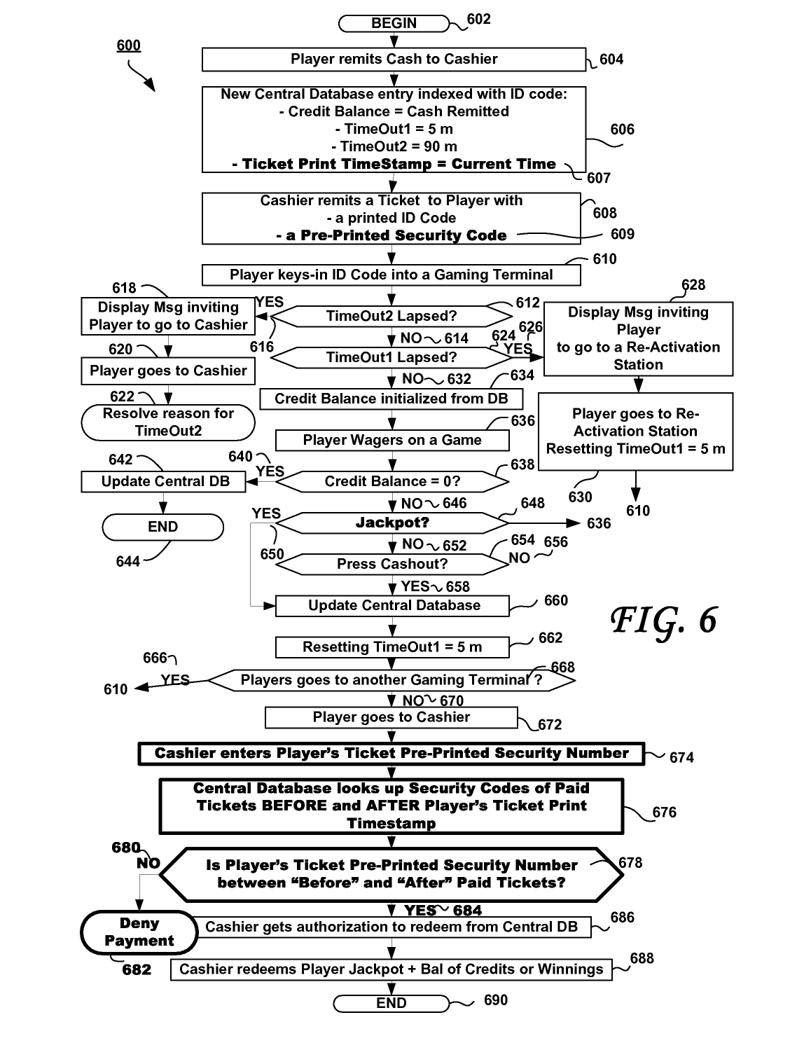

FIG. 6 illustrates a complete cash-in/cashless-play/cash-out cycle for a player according to a cashless procedure using the secure 2-level limited lifetime ticket method described relative to FIG. 3, supplemented with the use of a pre-printed security number (or security code, as the two phrases are used interchangeably herein) for significant additional security. Diagram 600 is identical to diagram 300 shown in FIG. 3 except for the steps in bold and the thicker line boxes shown at 607, 609, 674, 676, 678, 680, 682 and 684. For clarity, only these modified steps are detailed hereunder. According to this embodiment, for significant additional security whenever cashing out large winning sums such as subsequent to a progressive jackpot, as shown at 648 in which the win amount may be in the order of 20 million dollars, a third party security number (or security number or validation number) may be associated with the cashless payment instrument. For example, if the cashless payment instrument is a ticket printed on thermal paper, the identification code to be presented to the gaming machine may be printed on the ticket by the thermal printer at the moment of issue as shown at 608, and the security number may be preprinted on the back of the ticket as shown at 609 with an inking process when the paper spool is made (thus the number is chosen/printed by a third party and recorded on a central database that may be subsequently accessed when performing the payment verification procedure). Preferably, the security number may be printed in red such that it does not interfere with barcode scanning, as laser and CCD barcode readers are blind to the color red. The security numbers may be printed frequently at regular intervals, for example every 10 cm on the spool, such that each printed ticket after being cut may have at least one security number readable on its backside when remitted to the player. Security numbers may simply be unique sequential numbers printed on the back of the blank cashless ticket every 10 cm (for example), in which case, no record of these numbers need be communicated to anyone as successive numbers may be easily predicted.

When a ticket is issued, a timestamp may be being recorded in the central database 111, as shown at 607, together with other metadata information associated with the issue of the ticket.

When a ticket is presented by a player for redemption of winnings or remaining credits, then the cashier systematically records the security number found on the back of the cashless ticket, as shown at 674, together with any other details needed for the redemption. Considering that statistically they may be one (1) ticket presented for redemption out of ten (10) tickets initially issued, there is a recorded trace in the central database of 10% of the security numbers in a random distribution, to which is associated the exact time the original ticket was issued.

Therefore, when a player presents a suspicious or a very large sum winning ticket for redemption, the cashier after entering the identification code printed on the ticket (by scanning the barcode or other machine printed on the ticket) simply keys-in the security number (or one of the security numbers) 674 available on the back of the ticket, which cashless ticket is immediately processed at the central database 111. At numeral 676 678, the central database 111 recovers the exact issuing timestamp when the presented ticket was issued, and then retrieves the security numbers of the paid tickets that were originally issued before and after the presented ticket was issued. If the security number of the presented ticket is within the range delimited by the security numbers of the before ticket and the after ticket, then there is a high confidence that the ticket is genuine and the payment may be authorized, as shown at 684 and 686. Otherwise, payment is denied as shown at 680, 682.

It would be extremely difficult for a malicious person to forge a winning ticket having all three parameters correct: the identification code 206, the issuing timestamp 607 and the security number 212. Indeed, the security numbering scheme may be further hardened by having the paper spool maker print pseudo random numbers (instead of sequential numbers thus unpredictable by humans) which may be recorded in a central database 111 accessible by an authorized third party. During the verification process, the central database 111 (or the cashier) would submit the security number 212 of the presented ticket, the security number of the before ticket and the security number of the after ticket to the third party. The third party would then look-up the series of pseudo random numbers to confirm whether the security number of the presented ticket was pre-printed between the security number of the ticket having an issuing timestamp before the presented ticket and the security number of the ticket having an issuing timestamp after the presented ticket.

The cashless method described herein is simple yet sufficiently secure so as to be accepted by game regulators in small to medium size gaming operations, such as island holiday resorts, in cruise ships and on-board international flights in which having a player walk to a cashier or a re-activation station monitored by gaming personnel and/or video surveillance is acceptable.

If the identification code 206 is a password or pass phrase entered or submitted by the player, the need to print a ticket may be totally unnecessary, as the player may simply manually enter the password or pass phrase (or provide same by other means) each time he or she wishes to play on a gaming machine. This totally medium-free cashless method may be popular on board cruise ship, whereby during his several days journey a player may play at any time on any gaming machine on board the ship without having to carry cash or a ticket, especially in places in which carrying a ticket is inconvenient or prone to stealing such as at the swimming pool or at the gym.

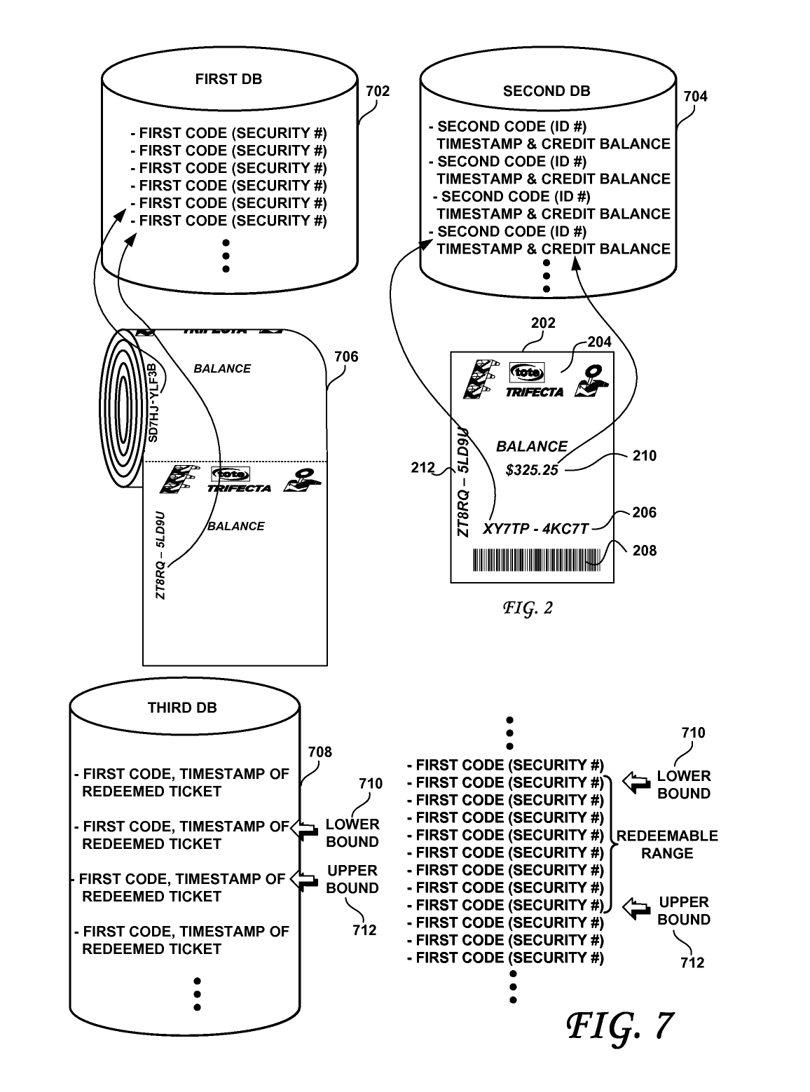

FIG. 7 shows further aspects of a cashless payment method for a gaming system having a plurality of network connected gaming machines, according to further embodiments of the present invention. As shown therein, a first database 702 may store first codes (e.g., security codes) for tickets to be issued to players. The first codes may be, according to embodiments of the present invention, pre-printed on the tickets (e.g., at the time of manufacture of the tickets). For example, the tickets to be eventually issued to players may be manufactured as a continuous spool 706 of partially blank tickets (on thermal paper, for example), with the first codes (sequential or pseudo-random) pre-printed thereon at a sufficiently close interval that when the individual tickets are separated from the spool, at least one of the pre-printed first (security) codes pre-printed thereon appear and are readable on the separated ticket. It is to be noted that the tickets to be issued to the players need not manufactured on a spool but may, for example, be manufactured as a stack of accordion-folded tickets or in any other manner deemed appropriate.

A second code (such as an identification code 206, for example) may be printed on the ticket 202 when the ticket is issued to the player. The ticket is issued to the player in exchange for money remitted by the player and a credit balance may be created for the player that is (or may be) equal to the money remitted. The second code is preferably independent of the pre-printed first code and is preferably generated and printed at the time of issuance independently of the printing of the first code on the ticket. As suggested by FIG. 7, the timestamp at which the ticket 202 was issued may be stored in a second database 704. The second database 704 may be independent of the first database 702. Along with the second code, the timestamp of the time at which the ticket was issued and the credit balance may also be stored in the second database 704. The timestamp and the credit balance may be associated with the second code stored in the second database 704. According to an embodiment of the present invention, the timestamp and the credit balance may be stored as metadata to the second code.

Metadata has multiple definitions, the briefest of which is “data about data.” Metadata may be generally thought of as information that describes, or supplements, the central data. For example, metadata produced by digital still cameras describe the settings used for the picture, such as exposure value or flash intensity. In such cases, the metadata can be considered as extra data, which merely add information, and is not critical to the functions of the main data. In other cases, metadata can be considered essential to the proper functioning of the main product. Since the difference between data and metadata is often subtle and context-specific, rigorous definitions are elusive.

Even when it is not essential to the proper functioning of a product, metadata is valuable because of the context that it provides, and the ways that contextual information can be used. When data is made available to a potential user, the user (human or computer) must put the data into an existing model of knowledge, and may ask questions to do so. For example, in the case of an image, typical questions include “When was this taken?” and “Who and what are in this image?” Metadata provides context to answer many of these questions. In sophisticated data systems, the metadata—the contextual information surrounding the data—will also be very sophisticated, capable of answering many questions that help understand the data.

The second database 704, therefore, may store a plurality of second codes (and associated timestamps and credit balances—which may be dynamically updated as the player wagers) of issued tickets.

A third database 708 may also be provided. The third database may be configured to store the pre-printed first codes and the timestamps associated with the second codes of previously redeemed tickets. The third database 708 may be used in combination with the first database 702 to determine whether a ticket presented for redemption is likely valid and authentic. For example, when a player has won a prize or has pressed a cash-out button upon presentation of a ticket, a redemption enabling step may be carried out to enable redemption of the balance of credit (which may be maintained within the gaming machine and/or retrieved from the second database 704). The player's balance of credit may be retrieved from the second database 704 using the second code 206 printed on the ticket 202. To determine whether a redemption request should be allowed or disallowed, embodiments of the present invention call for disallowing redemption unless the first code 212 pre-printed on the presented ticket falls within a determined range of first codes in the first database 702, this range of first codes being determined by timestamps associated with second codes of previously redeemed tickets. Indeed, with reference to the third database 708 of FIG. 7, lower and upper bounds 710, 712 may be established based upon timestamps associated with the second codes of previously redeemed tickets, which lower and upper bounds 710, 712 may delimit a redeemable range of first security codes in the first database 702. According to embodiments of the present invention, if the first code 212 of the ticket presented for redemption falls within the redeemable range of first codes, the redemption request is honored and the redemption enabled. The player may then be paid the balance of credit due.

According to an embodiment of the present invention, the lower bound 710 may be defined by a nearest first code of a first previously redeemed ticket that was issued before the presented ticket, as determined by the timestamp associated with the second code of the first previously redeemed ticket. Similarly, the upper bound 712 may be defined by a nearest first code of a second previously redeemed ticket that was issued after the presented ticket, as determined by the timestamp associated with the second code of the second previously redeemed ticket. Such lower and upper bounds 710, 712 delimit a redeemable range of first codes which, it is recalled, were pre-printed on the tickets (i.e., printed prior to issuance of the ticket to the player), as opposed to the second codes which may be printed (and generated) on the ticket at the time of issuance.

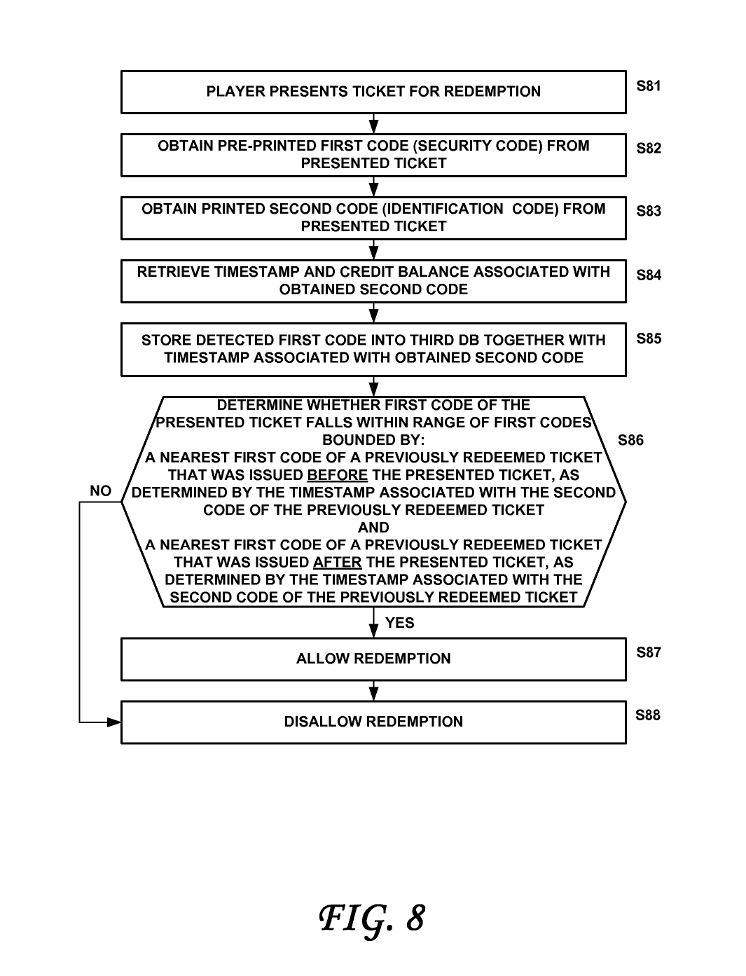

FIG. 8 is a flowchart illustrating aspects of a method for redemption of cashless tickets, according to further embodiments of the present invention. As shown therein, the method for redemption of cashless tickets may include an initial step S81 of a player presenting a ticket for redemption. The presented ticket may be the same ticket that was originally issued to the player when the player remitted money, a newly printed ticket from one of the gaming machines of the network or may be a cash-out ticket. Step S82 calls for obtaining (e.g., detecting by a scanner or otherwise) the pre-printed first code 212 (also called the security number or security code herein) from the presented ticket. Similarly, step S83 calls for the second code (also called the identification or ID code herein) 206 from the presented ticket. Other codes (e.g., 208) or security features may also be obtained from or checked in the presented ticket. As shown in step S84, the timestamp and credit balance associated with the detected second code may be obtained (e.g., retrieved from the second database 704. The timestamp and/or the credit balance may be stored in the database 704 (for example) as metadata to the second code stored therein. The precise manner in which the various data may be stored need not match that shown or described herein. Subject to regulatory and security concerns, the first and second codes, the timestamp and the credit balance (and other information) may be stored in most any manner such as, for example, as partitioned tables within a single database, wherein each record may be keyed, for example, by the first and/or second code. However, security concerns may dictate that the first and second codes (and associated timestamp and credit balance information) be stored independently.

As shown in step S85, an embodiment of the present invention calls for the detected first code 212 and the timestamp associated with the detected second code 206 be stored in a third database 708 that contains similar information for previously redeemed tickets (or cash-out tickets). Armed with the information obtained and stored in steps S81-S85, a redemption enabling step may be carried out by determining whether the first code 212 of the presented ticket falls within a range of first code bounded by a lower bound 710 and an upper bound 712. The lower bound 710 may be defined by a nearest first code of a first previously redeemed ticket that was issued before the presented ticket, as determined by the timestamp associated with the second code of the first previously redeemed ticket. Similarly, the upper bound 712 may be defined by a nearest first code of a second previously redeemed ticket that was issued after the presented ticket, as determined by the timestamp associated with the second code of the second previously redeemed ticket. If, after carrying out a lookup procedure on the first database 702, the presented ticket's first code 212 is determined to fall within the range delimited by the lower bound 710 and the upper bound 712, the ticket may be redeemed, as shown at S87. If, however, the lookup procedure on the first database 702, the presented ticket's first code 212 is determined to fall outside of the redeemable range of first codes within the database 702 (that is, outside of the range delimited by the lower bound 710 and the upper bound 712), redemption of the ticket may be disallowed, as shown at S88.

The gaming machine and/or the machine or device on which the player redeems his or ticket on which the player wagers may include any number of user interface devices, such as a keyboard and/or a keypad, touchscreen or a pointing device. The second code 206 may use such user interface devices to manually enter the second code printed on the ticket presented for redemption. The second code may include most any symbols, most any alphanumeric code, a password and/or a pass-phrase.

Additional security measures may be required for redemption. For example, when the ticket is issued to the player, the player may be required to enter or otherwise provide a first Personal Identification Number (PIN). This first PIN may be stored, e.g., in the second database 704 (as metadata to the second code, for example, or otherwise associated with the second code). The redemption enabling step may then include a step of requiring the player to enter or otherwise provide a second PIN. The redemption step may then be disallowed unless the second PIN matches or otherwise corresponds to (or completes) the first PIN stored in the second central database 704.

According to further embodiments of the present invention, the pre-printed first codes on sequentially issued tickets may be sequential or random (e.g., pseudo-random). That is, the first codes 212 on the spool 706 of tickets may be sequential or pseudo-random (generated by a random number generator). When the ticket is issued to the player in exchange for money remitted, the ticket may be separated from the spool 706 of tickets (or stack of tickets—however the tickets were manufactured) in such a manner that after the separating step, at least one of the pre-printed first codes 212 is readable on the ticket issued to the player. This may be accomplished by printing the first codes at fairly close intervals on the tickets or cash-out tickets.

Advantageously, the time stamp associated to the ticket subject to a redemption request may be used to retrieve information for confirming that the security number printed on the ticket exists in a first database and thus that the ticket is authentic, using a lookup technique—based on previously redeemed tickets whose security numbers were recorded in a second database at the time of their redemption—to find the nearest upper neighbor security number and the nearest lower neighbor security number (first codes) according to the consecutive order which they were printed as recorded in the first database (the first database and the second database being populated independently), before authorizing the redeeming of credits; there is no date/time limit associated to the timestamp subsequent to which the authentication may fail. The authentication purpose is not for playing the credit on a gaming machine but is a strong verification technique enabling the gaming operator to redeem prizes on the order of millions of dollars with confidence.

Although specific embodiments have been illustrated and described herein, it will be appreciated by those of skill in the art that any arrangement that is calculated to achieve the same purpose may be substituted for the specific embodiments shown. This application is intended to cover any adaptations or variations of the present invention. For example, the pre-printed security number scheme may be used alone without the 2-level limited lifetime ticket method described.

What is claimed is:

1. A cashless payment method for a gaming system having a plurality of network connected gaming machines, comprising the steps of:
issuing a ticket in exchange for money remitted by a player, the ticket including a first code that is pre-printed on the ticket and is indexed in a first database and a second code that is printed, independently of the first code, on the ticket at a time of issuance of the ticket and that is indexed in a second database that is independent of the first database, the second database storing a timestamp of a time at which the ticket was issued and a balance of credit set to the money remitted, the timestamp and the balance of credit being associated with the second code;
accepting the issued ticket by a gaming machine of the gaming system selected by the player and crediting the gaming machine with the balance of credit associated with the second code printed on the ticket, the balance of credit being retrieved from the second database;
enabling wagering on the gaming machine and updating the balance of credit in the second database as long as the balance of credit is greater than zero, and disallowing wagering when the balance of credit is zero, and
enabling redemption of the balance of credit when the player has won a prize or has pressed a cash out button upon presentation of the ticket, the balance of credit being retrieved from the second database using the second code printed on the ticket, the redemption enabling step being rejected if the first code pre-printed on the presented ticket does not fall within a determined range of first codes in the first database, the range of first codes being determined by timestamps associated with second codes of previously redeemed tickets.

2. The method of claim 1, wherein the first code includes a security code and wherein the second code includes an identification code.

3. The method of claim 1, wherein the issuing step is carried out with the timestamp and the balance of credit being stored in the second database as metadata associated with the second code.

4. The method of claim 1, wherein the redemption enabling step is carried out with the range of first codes being bounded by:
a nearest first code of a first previously redeemed ticket that was issued before the presented ticket, as determined by the timestamp associated with the second code of the first previously redeemed ticket, and
a nearest first code of a second previously redeemed ticket that was issued after the presented ticket, as determined by the timestamp associated with the second code of the second previously redeemed ticket.

5. The method of claim 1, wherein the gaming machine includes at least one of a keyboard/keypad, touchscreen and a pointing device.

6. The method of claim 5, wherein the accepting step includes a step of accepting manual entry of the second code of the presented ticket via the at least one of the keyboard/keypad, touchscreen and the pointing device.

7. The method of claim 1, wherein the second code includes at least one of an alphanumeric code, a password and a pass-phrase.

8. The method of claim 1, wherein the redemption enabling step includes printing a cash-out ticket, wherein the cash-out ticket is the ticket.

9. The method of claim 1, wherein the issuing step further includes a step of accepting a first Personal Identification Number (PIN) from the player, the first PIN being stored in the second database and associated with the second code and wherein the redemption enabling step further includes a step of accepting a second PIN from the player, and disallowing redemption if the second PIN does not match the first PIN stored in the second central database.

10. The method of claim 9, wherein the first PIN is stored in the second database as metadata to the second code.

11. The method of claim 1, wherein the pre-printed first codes on sequentially issued tickets are one of sequential and pseudo-random.

12. The method of claim 1, wherein the ticket issuing step includes a step of separating the issued ticket from a spool of tickets, the spool of tickets including a plurality of tickets having first codes pre-printed thereon in such a manner that after the separating step, at least one of the pre-printed first codes is readable on the ticket issued to the player.

13. The method of claim 8, wherein the ticket issuing step includes a step of separating the issued ticket from a spool of cash-out tickets, the spool of cash-out tickets including a plurality of cash-out tickets having first codes pre-printed thereon in such a manner that after the separating step, at least one of the pre-printed first codes is readable on the cash-out ticket issued to the player.

14. A cashless payment method for a gaming system having a plurality of network connected gaming machines, comprising the steps of:
issuing a ticket in exchange for money remitted by a player, the ticket including a first code that was pre-printed during manufacturing of the ticket and a second code that is printed on the ticket at a time of issuance of the ticket;
recording a timestamp of a time at which the ticket was issued and a balance of credit set to the money remitted, and associating the recorded timestamp and the balance of credit with the second code;
accepting the issued ticket by a gaming machine of the gaming system selected by the player and crediting the gaming machine with the balance of credit associated with the second code printed on the ticket;
enabling wagering on the gaming machine and updating the balance of credit in the second database as long as the balance of credit is greater than zero, and disallowing wagering when the balance of credit is zero, and
enabling redemption of the balance of credit when the player has won a prize or has pressed a cash out button upon presentation of the ticket, the redemption enabling step being rejected if the first code pre-printed on the ticket does not fall within a determined range of first codes, the range of first codes being determined by recorded timestamps associated with second codes of previously redeemed tickets.

15. The method of claim 14, wherein the first code includes a security code and wherein the second code includes an identification code.

16. The method of claim 14, wherein the timestamp and the balance of credit being recorded as metadata associated with the second code.

17. The method of claim 14, wherein the redemption enabling step is carried out with the range of first codes being bounded by:
a nearest first code of a first previously redeemed ticket that was issued before the presented ticket, as determined by the timestamp associated with the second code of the first previously redeemed ticket, and
a nearest first code of a second previously redeemed ticket that was issued after the presented ticket, as determined by the timestamp associated with the second code of the second previously redeemed ticket.

18. The method of claim 14, wherein the gaming machine includes at least one of a keyboard/keypad, touchscreen and a pointing device.

19. The method of claim 18, wherein the accepting step includes a step of accepting manual entry of the second code of the presented ticket via the at least one of the keyboard/keypad, touchscreen and the pointing device.

20. The method of claim 14, wherein the second code includes at least one of an alphanumeric code, a password and a pass-phrase.

21. The method of claim 14, wherein the redemption enabling step includes printing a cash-out ticket, wherein the cash-out ticket is the ticket.

22. The method of claim 14, wherein the issuing step further includes a step of accepting a first Personal Identification Number (PIN) from the player, the first PIN being associated with the second code and wherein the redemption enabling step further includes a step of accepting a second PIN from the player, and disallowing redemption if the second PIN does not match the first PIN.

23. The method of claim 22, wherein the first PIN is stored as metadata to the second code.

24. The method of claim 14, wherein the pre-printed first codes on sequentially issued tickets are one of sequential and pseudo-random.

25. The method of claim 14, wherein the ticket issuing step includes a step of separating the issued ticket from a spool of tickets, the spool of tickets including a plurality of tickets having first codes pre-printed thereon in such a manner that after the separating step, at least one of the pre-printed first codes is readable on the ticket issued to the player.

26. The method of claim 21, wherein the ticket issuing step includes a step of separating the issued ticket from a spool of cash-out tickets, the spool of cash-out tickets including a plurality of cash-out tickets having first codes pre-printed thereon in such a manner that after the separating step, at least one of the pre-printed first codes is readable on the cash-out ticket issued to the player.
